(19) United States
(12) Patent Application Publication
(10) Pub. No.: US 2026/0145647 A1
(43) Pub. Date: May 28, 2026

(54) WIPER BLADE, IN PARTICULAR FOR A MOTOR VEHICLE

(71) Applicant: Robert Bosch GmbH, Stuttgart (DE)

(72) Inventors: Patrick Vix, Offendorf (FR); Swen Koehn, Karlsruhe (DE)

(21) Appl. No.: 19/379,994

(22) Filed: Nov. 5, 2025

(30) Foreign Application Priority Data
Nov. 26, 2024 (DE) 10 2024 211 304.2

(51) Int. Cl. B60S 1/04

(52) U.S. Cl. CPC B60S 1/0408

(57) ABSTRACT

A wiper blade, in particular for a motor vehicle, is proposed. The wiper blade includes a wiper strip and a retaining spring having a spoiler-like surface. The spoiler-like surface is at least partially formed as an air layer holding surface, in particular with a plurality of dents.

### BACKGROUND

The invention relates to a wiper blade according to the disclosure.

Some wiper blades with a wiper strip and a retaining spring are already known, in which the retaining spring has a spoiler-like surface.

For example, DE 102013220255 A1 shows such a wiper blade in which the surface of the retaining spring is arranged obliquely to the direction flowed by the wind of travel so that a spoiler-like structure is generated that favorably affects the aerodynamic conditions.

### SUMMARY

The wiper blade according to the invention with the features of the disclosure has the advantage that the spoiler-like surface is configured as at least partially as an air layer holding surface, in particular with a plurality of dents. This further improves the aerodynamic conditions and in particular reduces water withdrawal upon reversing the direction of movement of the wiper, and increases the pressing force on the windshield to be wiped.

Advantageously and purposefully, the air layer holding surface is arranged facing the wind.

Simple, inexpensive and therefore advantageous, the provided dents are arranged regularly.

The dents are particularly effective and therefore advantageous if they are spherical-segment shaped and have a diameter of between 1 mm and 5 mm, especially between 2 mm and 4 mm, preferably around 3 mm.

Optimal interference on aerodynamic conditions is advantageously achieved by arranging the dents substantially over the entire surface.

A further improvement is advantageously achieved by the wipe strip having a spoiler-like wind deflection strip.

In this case, it is particularly advantageous if the wind deflector strip also has dents for generating an air layer holding surface.

In a simple, inexpensive and therefore advantageous embodiment, a spring strip is provided that is pre-curved in the relaxed state.

### BRIEF DESCRIPTION OF THE DRAWINGS

One exemplary embodiment of the invention is shown in the drawings and explained in further detail in the following description. The figures show:

FIG. 1 shows a wiper lever with a wiper blade according to the invention in a perspective view,

FIG. 2 shows the wiper blade of FIG. 1 with the retaining spring in detail,

FIG. 3 shows a schematic representation of the surface of the retaining spring; and

FIG. 4 shows the surface of FIG. 3 in a variation.

### DETAILED DESCRIPTION

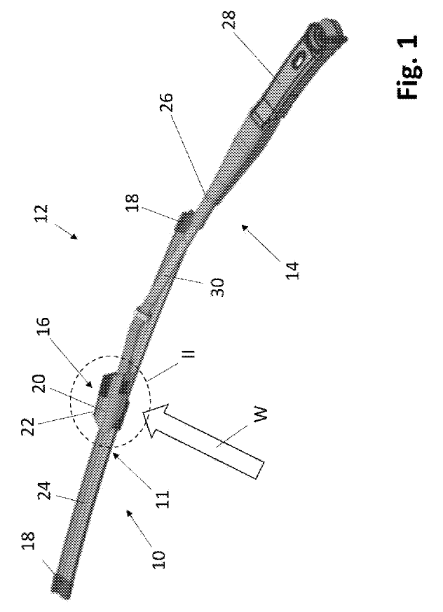

In FIG. 1, a wiper blade 10 in a wiper lever 12 according to the invention is shown in a perspective representation. The wiper lever 12 includes the wiper blade 10 attached to a free end of a wiper arm 14. The free end of the wiper arm 14 is the end that faces away from a shaft that can move the wiper arm 14 into a swaying motion.

A retaining spring 16 is provided to attach the wiper blade 10 to the wiper arm 14. The free end of the wiper arm 14 is inserted and locked into the retaining spring 16 to secure the wiper blade 10.

Along its longitudinal extension, the wiper blade 10 is bounded by an end cap 18 at each end.

The retaining spring 16 is arranged approximately centrally along the longitudinal extension of the wiper blade 10.

Furthermore, the retaining spring 16 is connected to the remaining wiping blade 10 in a swaying manner, which is referred to herein as wiper strip 11. A joint is provided for this purpose, which is arranged between the retaining spring 16 and the remaining wiper blade 10. This allows the remaining wiper blade 10 to move in a swaying manner relative to the wiper arm 14 when there is a rigid connection between the wiper arm 14 and the retaining spring 16, in order to compensate for different contact angles on the windshield to be wiped.

The retaining spring 16 made of plastic, in particular as an injection molding part.

During operation, the wiper blade 10 is exposed to airflow, which is symbolized in the figure by the directional arrow W.

The retaining spring 16 has a spoiler-like surface 20. The spoiler-like surface 20 is particularly spoiler-like because it is inclined towards the wind of travel, i.e., its side facing the airflow is lower than the side of the wiper blade 10 facing away from the airflow, thereby improving the aerodynamics of the retaining spring 16.

The spoiler-like surface 20 also has an S-shape in cross-section, such that a tear-off edge 22 is formed on the side of the retaining spring 16 facing away from the wind of travel.

Furthermore, the spoiler-like surface 20 is configured convex in sections.

The wiper blade 10 according to the invention furthermore comprises a wind deflector strip 24 along its longitudinal extension, which, like the retaining spring 16, is inclined, i.e. on its side facing the wind of travel, runs at a lower height than on the side of the wiper blade 10 facing away from the wind of travel. The wind deflection strip 24 has a groove in this case and is therefore concave in cross-section.

The wiper arm 14 includes a joint 26 that is connected in an articulated manner to a mounting portion 28. The mounting portion 28 is connected to a wiper shaft after mounting on the vehicle, which during in operation places the wiper lever 12 in a swaying motion. The joint 26 has a wiper rod 30 on its free end, which faces away from the fastening part 28, which is inserted into the retaining spring 16, as already explained above.

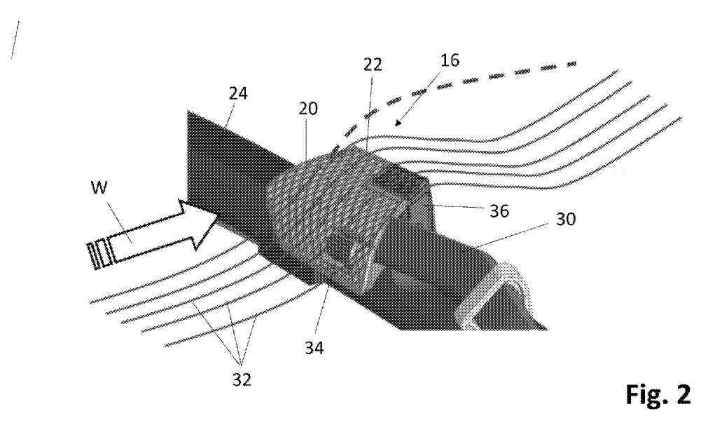

In FIG. 2, an excerpt with the retaining spring 16 is shown in detail. In the following, only the details that have not yet been explained in FIG. 1 are described. In this respect, the statements regarding FIG. 1 also apply here.

The retaining spring 16 has a spoiler-like surface 20, which has a convex and a concave portion.

The airflow through the wind of travel is symbolized by arrow W. The flow resulting from the wind of travel is indicated by flow lines 32. The concave section, which is bounded by the tear-off edge 22, is located on the upstream side of surface 20.

The surface 20 is furthermore formed in multiple pieces, so a release button 34 is integrated into the surface 20 for unlocking the wiper rod 30.

Furthermore, a spray device 36 is integrated in the retaining spring 16 such that it also forms part of the surface 20.

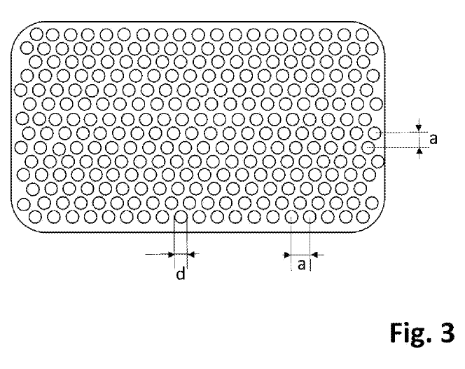

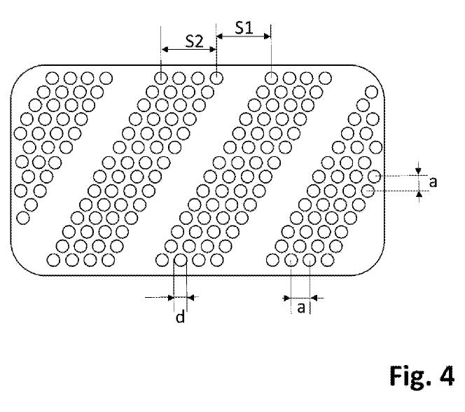

The entire surface 20 is provided with a plurality of small dents 38 (FIGS. 3 and 4) forming an air layer holding structure 40. In a variation of the invention, the release button 34 and/or the spraying means 36 may be omitted from the dents 38.

The dents 38 are formed as circular indentations and cause a thin air layer to adhere to the surface 20 during operation. This thin air layer causes a laminar flow of the incoming travel of wind via the retaining spring 16 or the surface 20, whereby particularly disturbing wind noises are reduced.

The depth of the dents 38 is a maximum of 1.5 millimeters, in particular less than 1 millimeter. The diameter d (FIG. 3) of the dents 38 is between 1 millimeter and 5 millimeters, in particular between 2 millimeters and 4 millimeters, it is about 2.5 to 3 millimeters.

In FIG. 3, the surface 20 is shown schematically. The dents 38 are regularly arranged and have a diameter d of about 2.5 millimeters. The distance a between the dents 38 is 2.5 millimeters and 5 millimeters. The dents 38 may be located directly adjacent each other, spacing a just equal to the diameter D of the dents 38. Actively, the dents 38 may have a distance a from each other but that is at most twice the diameter d of the dents 38. Distance a is herein referred to the distance between two centers of two dents 38, thus the distance a between midpoints of dents 38.

The dents 38 are circular here, and form – spatially considered – sphere sections. Alternatively, instead of this circular shape, the dents 38 can also be polyhedron or polygon-shaped, for example square, thus rectangular, hexagonal, triangular or octagonal on the surface 20.

In a variation of the invention, the air layer holding structure 40 formed by the dents 38 may also be provided only in sections on a part of the surface 20.

For example, the air layer holding structure 40 caused by the dents 38 can also be provided in horizontal strips extending along the longitudinal extension of the wiper blade 10.

In a further variation, the air layer holding structure 40 can also be arranged in perpendicular strips or in transverse strips, as shown in FIG. 4.

In FIG. 4, a variation of the surface 20 of FIG. 3 is shown.

The air layer holding structure 40 is arranged here in transverse strips, each having a strip spacing distance S1 from each other, which corresponds to the distance of the dents 38 between two strips.

The strips themselves have a strip width S2 that corresponds to the distance between the outermost dents 38 of the strip.

The strip spacing S1 and strip width S2 are approximately equal in size. However, in one variation, the strip spacing S1 may be greater than or less than the strip width S2. Other, regular arrangements of the strips are also possible here. For example, two different strip spacings S2 may alternate or the strip portions may gradually become larger from one side to the other side, resulting in a Fibonacci-like structure.

In a further variation, circle portions or elliptical portions may also be provided instead of strips.

Generally, the dents 38 may be arranged as desired, but in particular, regular patterns of the dents 38 are also preferable for optical reasons.

In a further variation of the invention, the dents 38 may also be provided on the wind deflection strip 24. Again, a strip-shaped arrangement is possible, for example shown in FIG. 4.

1. A wiper blade (10) comprising a wiper strip (11) and a retaining spring (16) having a spoiler-like surface (20), wherein the spoiler-like surface (20) is at least partially formed as an air layer holding surface (20).

2. The wiper blade (10) according to claim 1, wherein the air layer holding surface (20) is arranged facing the wind.

3. The wiper blade (10) according to claim 10, wherein the dents (38) are regularly arranged.

4. The wiper blade (10) according to claim 10, wherein the dents (38) are spherical-segment shaped and have a diameter of between 1 mm and 5 mm.

5. The wiper blade (10) according to claim 10, wherein the dents (38) are substantially arranged on an entirety of the air layer holding surface (20).

6. The wiper blade (10) according to claim 1, wherein the wiper strip (11) comprises a spoiler-like wind deflection strip (24).

7. The wiper blade (10) according to claim 6, wherein the wind deflection strip (24) comprises dents (38) for generating an air layer holding surface.

8. The wiper blade (10) according to claim 1, wherein the wiper strip (11) comprises a spring strip that is pre-curved in a relaxed state.

9. The wiper blade (10) according to claim 1, wherein the air layer holding surface (20) is arranged in strips.

10. The wiper blade (10) according to claim 1, wherein the air layer holding surface (2) includes a plurality of dents (38).

11. The wiper blade (10) according to claim 4, wherein the dents (38) have a diameter of between 2 mm and 4 mm.

12. The wiper blade (10) according to claim 11, wherein the dents (38) have a diameter of about 3 mm.

13. The wiper blade (10) according to claim 9, wherein the air layer holding surface (20) is arranged in transverse strips on the retaining spring (16).
